(19) United States
(12) Patent Application Publication
(10) Pub. No.: US 2018/0326934 A1
(43) Pub. Date: Nov. 15, 2018

(54) System For Assembling Two Parts With Built-In Guide Member And Locking Element

(71) Applicant: Compagnie Plastic Omnium, Lyon (FR)

(72) Inventor: Olivier CORNET, Miribel (FR)

(73) Assignee: Compagnie Plastic Omnium, Lyon (FR)

(21) Appl. No.: 15/777,504

(22) PCT Filed: Nov. 10, 2016
(86) PCT No.: PCT/FR2016/052918

§ 371 Date: May 18, 2018

(30) Foreign Application Priority Data
Nov. 18, 2015 (FR) 1561078

(51) Int. Cl. B60R 19/18; F16B 5/06; F16B 21/16

(52) U.S. Cl. CPC B60R 19/18; B60R 2019/1886; F16B 21/16; F16B 5/0657

(57) ABSTRACT

The invention relates to an assembly including a first part and a second part that is part of the body of a motor vehicle, the first part being intended for assembly on the second part. The second part has a projecting element extending along a main axis X, the first part including a holder provided with a guide member for guiding the first part relative to the projecting element, the holder supports an element for locking the projecting element in a position for assembly of the first part on the second part, the locking element is configured to lock the projecting element in the assembly position via movement along an axis separate from the main axis X.

### FIELD OF THE INVENTION

This invention relates to the automotive field, and in particular to an assembly including a first part and a second part that is part of the body of a motor vehicle, the first part being intended for assembly on the second part.

### BACKGROUND OF THE INVENTION

On a motor vehicle, it is customary to add parts which are intended to be attached to the outside of the vehicle. Such a part (called the first part), is for example a bumper, and is assembled on a part of the bodywork or body (called the second part) of the vehicle. This part is for example a vehicle beam. To produce this assembly, this part of the vehicle and/or this first part must be provided with hooking elements. For example, a hooking element is attached using rivets or screws/nuts to this part, then the first part is clipped to this hooking element. Alternatively, a hooking element provided with screws is attached to the first part, then the assembly consisting of this first part and this hooking element is assembled on the part of the vehicle using these screws.

In all cases, rivets or screws/nuts are used to attach the first part on a part of the vehicle by means of hooking elements.

Such an attachment method requires manual assembly operations involving the use of tools. These operations are therefore long, expensive and slow down the production of the vehicle on the assembly line.

### SUMMARY OF THE INVENTION

This invention aims to overcome these disadvantages.

The invention aims to propose an assembly comprising a second part that is part of the body of a motor vehicle and a first part intended for assembly on the second part, these two parts being assembled as quickly and easily as possible.

This object is achieved by the fact that
the second part comprises a projecting element extending along a main axis X,
the first part comprises a holder provided with a guide member for guiding the first part relative to the projecting element,
the holder supports an element for locking the projecting element in a position for assembly of the first part on the second part,
the locking element is configured to lock the projecting element in the assembly position via a movement along an axis separate from the main axis X.

Thanks to these arrangements, the first part is assembled on the second part without the need for a specific assembly tool (screwdriver, riveter) or attachment element to be added (screw, rivet, clip, washer), therefore in a single operation.

Since the first part has a guide member and a locking element, these two parts can be assembled more easily and more quickly.

The assembly according to the invention forms a system for assembling two parts with built-in guide member and locking element.

The invention also relates to a method for assembling a first part on a second part that is part of the body of a motor vehicle.

According to the invention, the method comprises the following steps:

(a) Providing a first part which comprises a holder provided with a guide member, the holder supporting a locking element, and a second part which comprises a projecting element extending along a main axis X,
(b) Bringing the first part and the second part together so that the guide member guides the first part relative to the projecting element,
(c) Moving the locking element along an axis separate from the main axis X so as to lock the projecting element in the attachment position relative to the guide member, this attachment position being the assembly position.

### BRIEF DESCRIPTION OF THE DRAWINGS

The invention will be clearly understood and its advantages will appear on reading the detailed description below, of an embodiment represented as a non-limiting example. The description refers to the attached drawings, on which:

FIG. 1 is a side view showing an assembly according to the invention before being in the assembly position,

FIG. 2 is a side view showing an assembly according to the invention in the intermediate assembly position,

FIG. 3 is a side view showing an assembly according to the invention in the final assembly position,

FIG. 4 is a front view showing the locking element,

FIG. 5 is a cross-sectional view of the locking element of FIG. 4 along the plane V-V with the projecting element,

FIG. 6 is a view showing the projecting element and the locking element according to another embodiment of the invention,

FIG. 7 is a view showing the projecting element and the locking element according to yet another embodiment of the invention.

### DETAILED DESCRIPTION OF THE INVENTION

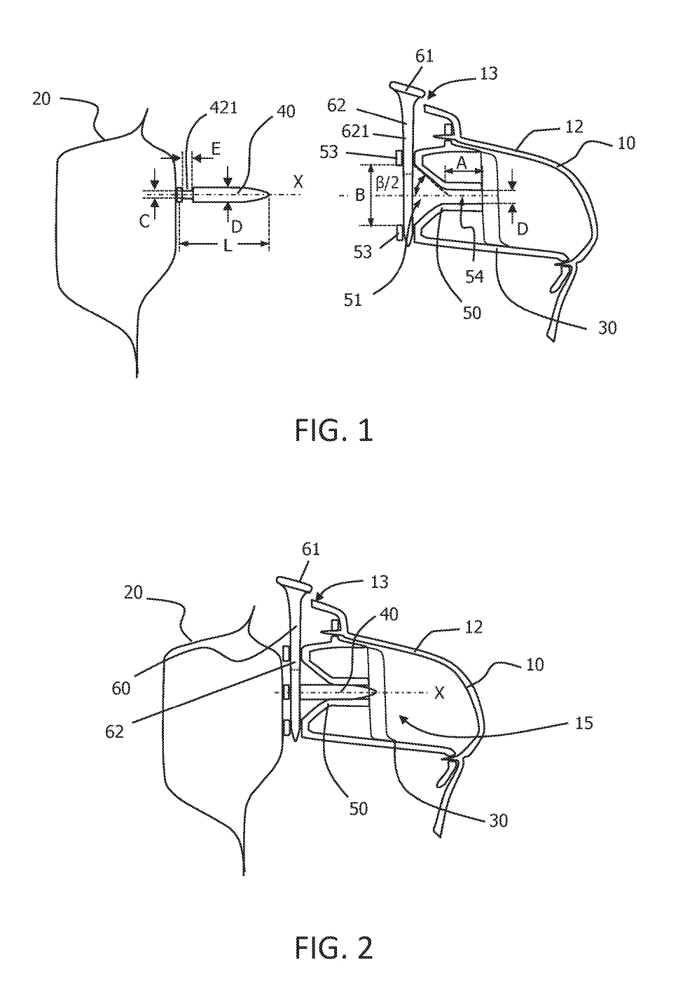

FIG. 1 shows a part of the body of a motor vehicle, this part forming a second part 20. The second part 20 comprises a projecting element 40 which extends along a main axis X. This projecting element 40 is a rod which is attached at one of its ends by welding or bonding to the second part 20. The projecting element 40 extends substantially perpendicular to the surface of the portion of the second part 20 to which it is attached.

Alternatively, this attachment is made by mechanical assembly (screwing, riveting, clipping). This solution is less attractive since it requires the addition of elements for sealing between the projecting element 40 and the second part 20 and for drilling the second part 20.

Alternatively, the projecting element 40 is an integral part of the second part 20.

Thus, the projecting element 40 and the second part 20 are made in one piece, for example by molding the same material.

In all cases, according to the invention, the connection between the projecting element 40 and the second part 20 is sufficiently strong, and the projecting element 40 sufficiently rigid, so that this projecting element can support at least some of the weight of the first part 10.

FIG. 1 shows a cross-sectional view of a first part 10, in this case a bumper. The first part 10 is located on the outside of the vehicle. The first part 10 comprises a holder 30 which is attached to the first part 10. This attachment is made for example by welding, clipping, stapling, bonding, riveting. The holder 30 may also be molded directly with the rest of the first part 10.

In all cases, it is advantageous that these attachment elements should not be visible from the outside when the first part 10 is in the assembly position on the second part 20 (see below).

Advantageously, the holder 30 is mounted on the first part 10, before the latter is assembled with the second part 20.

Preferably, the holder 30 is located relative to the rest of the first part 10 so that it is not visible from the outside when the first part 10 is in the assembly position on the second part 20 (see below). This is the case in particular when the first part 10 is a bumper.

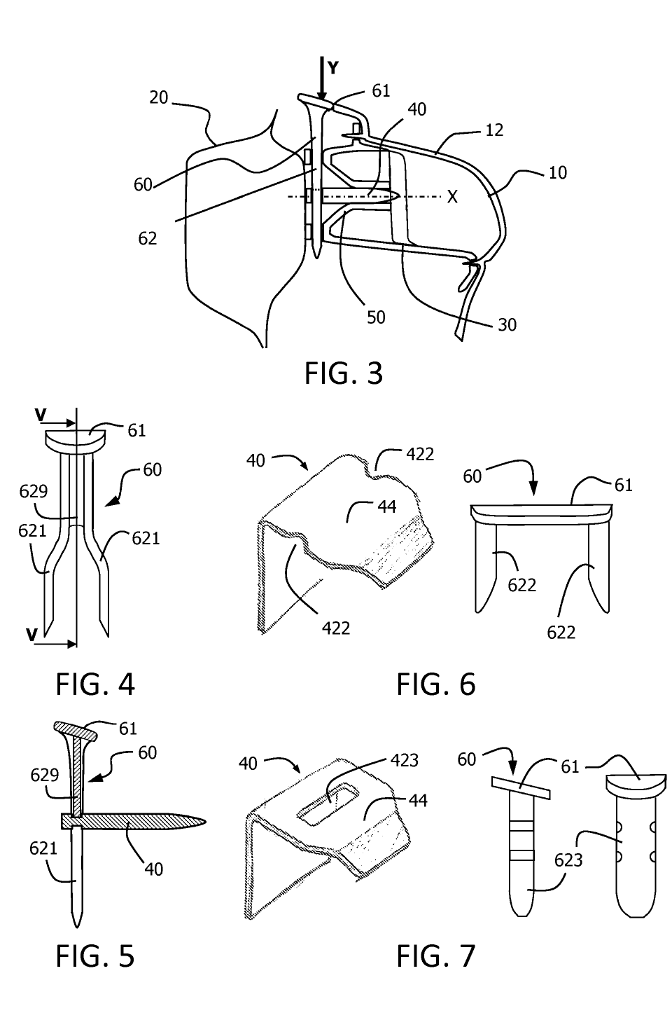

Thus, the holder 30 is located between the second part 20 of the vehicle body and the rest of the first part 10, so that the holder 30 is hidden (from the outside) by the rest of the second part 20. In the case of a bumper shown on FIG. 1, FIG. 2 and FIG. 3, the holder 30 is attached to the concave side of the rest of the first part 10, this concave side being directed towards the rear of the vehicle.

Thus, advantageously, the first part 10 has an internal space 15 housing the holder 30 and the guide member 50 (described below), so that the holder 30 and the guide member 50 are invisible from outside the vehicle in the assembly position.

The holder 30 is provided with a guide member 50. This guide member 50 is adapted to be able to guide the projecting element 40 during the assembly of the first part 10 with the second part 20. For example, as shown on FIG. 1, FIG. 2 and FIG. 3, the guide member 50 has a hole with an opening 51. The wall of the hole flares out towards the opening 51. For example, the hole is formed by a wall of the holder 30 which is folded back on itself.

Thus, the hole of the guide member 50 has at its opening 51 a flared portion which narrows gradually as it goes inside the hole and which is extended by a straight portion 54 of length A.

When the first part 10 is assembled on the second part 20, the projecting element 40 enters the hole through the opening 51. The flared shape of the hole of the guide member 50 at the opening 51 allows guiding during assembly of the projecting element 40 relative to the guide member 50, as shown on FIG. 2 and FIG. 3.

The assembly position of the first part 10 with the second part 20 corresponds to the attachment of these two parts.

The holder 30 supports a locking element 60. This locking element 60 is configured to lock the projecting element 40 in the assembly position of the first part 10 with the second part 20, once the projecting element 40 has been inserted inside the hole of the guide member 50. This locking is carried out by cooperation between the locking element 60 and the projecting element 40 such that the projecting element can no longer be removed from the hole (the opening 51) of the guide member 50. This locking prevents the two parts from separating. This locking is carried out by a translation of the locking element 60 (relative to the holder 30) along a Y axis separate from the main axis X and in a given direction (locking direction). A separate axis means an axis which makes a non-zero angle with the axis X. The attachment between the first part 10 and the second part 20 is therefore easier.

In the embodiment shown on the figures, the movement of the projecting element 40 is along a direction (axis) substantially perpendicular to the main axis X. The main axis X is preferably substantially the longitudinal axis of the vehicle. Thus, the Y axis and the locking direction are indicated on FIG. 3 by a vertical arrow. The locking element 60 is mounted on the holder 30 so that it can be translated along this separate Y axis.

To detach the first part 10 from the second part 20, the locking element 60 must be translated in the direction opposite to that which allowed it to cooperate with the projecting element 40.

For example, as shown on FIG. 1, FIG. 2 and FIG. 3, the locking element 60 is supported directly by the guide member 50.

The first part 10, second part 20, the holder 30, the projecting element 40, the guide member 50 and the locking element 60 are part of the assembly according to the invention.

FIG. 1 shows the first part 10 before it is assembled with the second part 20. The projecting element 40 has not yet entered the hole of the guide member 50.

FIG. 2 shows the first part 10 and the second part 20 in the intermediate assembly position, after guiding the projecting element 40. The projecting element 40 has entered the hole of the guide member 50 through the opening 51, helped by the flared wall of the hole which centred the projecting element 40 in this hole. At this stage, the locking element 60 does not lock the projecting element 40.

FIG. 3 shows the first part 10 and the second part 20 in the (final) assembly position. The locking element 60 is translated (lowered) along the Y axis in the direction of the arrow so that it locks the projecting element 40.

FIG. 4 shows the locking element 60 used in the assembly shown on FIG. 1, FIG. 2 and FIG. 3. FIG. 4 shows the locking element 60 in front view, i.e. in a plane perpendicular to the main axis X after assembly.

The locking element 60 comprises a head 61.

In the embodiment illustrated on FIG. 4, and in the embodiments illustrated on FIG. 6 and FIG. 7 (see below), the locking element 60 comprises a body 62 which cooperates with the projecting element 40 to lock this projecting element 40 in the hole of the guide member 50, in the assembly position.

This geometry simplifies this assembly.

FIG. 5 is a cross-sectional view of the locking element 60 seen along the plane V-V of FIG. 4. The projecting element 40 is also shown in cross-section in its position relative to the locking element as illustrated on FIG. 3.

As illustrated on FIG. 4 and FIG. 5, the body 62 comprises a fork with two arms 621, and the projecting element 40 has a groove 421 which receives the two arms 621 in the assembly position.

The projecting element 40 is a rod, and the groove 421 extends around at least some of the circumference of this rod. For example, the groove 421 may consist of two separate lateral grooves (i.e. these two lateral grooves are connected). For example, as shown on FIGS. 1, 2, 3, and 5, the groove 421 is circumferential and goes around this rod, this groove 421 being centred on the main axis X. The groove 421 is positioned so that it is opposite the body 62 when the first part 10 and the second part 20 are in the assembly position.

The distance between the arms 621 decreases from their distal end towards the head 61 until it becomes, at a certain distance from the head 61, substantially equal to the diameter of the projecting element 40 at the groove 421 (narrowed diameter of the projecting element 40 at the groove 421). Thus, when the body 62 is lowered towards the projecting element 40, the two arms 621 of the fork are inserted into the groove 421 on each side, so that the projecting element 40 is positioned between these two arms 621 and these arms 621 prevent, by mechanical cooperation, the projecting element 40 from being removed from the hole of the guide member 50. The first part 10 and the second part 20 are thus locked together.

FIG. 6 illustrates another embodiment of the invention in which the locking element 60 and the projecting element 40 have a different geometry.

The body 62 comprises two lateral rods 622 and the projecting element 40 has two lateral grooves 422 which each receive one of the two lateral rods 622 in the assembly position.

Thus, the projecting element 40 is a plate 44 which comprises on each of its lateral edges a lateral groove 422 which is a notch in a lateral edge of the plate 44.

The two lateral rods 622 extend from the ends of the head 61 of the locking element 60 perpendicular to this head 61. The width of the head 61 between the two lateral rods 422 is substantially equal to the width of the plate 44, so that when the locking element 60 is translated towards the projecting element 40, the two lateral rods 622 are inserted in the lateral grooves 422. The projecting element 40 is thus attached to the locking element 60.

FIG. 7 illustrates another embodiment of the invention in which the locking element 60 and the projecting element 40 have a different geometry.

The body 62 comprises a central rod 623 and the projecting element 40 has a hole 423 which is crossed by the central rod 623 in the assembly position.

The projecting element 40 is a plate 44 which has a central hole 423 in its middle. For example, this central hole 423 extends perpendicular to the main axis X, as illustrated. The central rod 623 extends from the middle of the head 61 of the locking element 60 perpendicular to this head 61. The width of the central rod 623 is substantially equal to the width of the hole 423, so that when the locking element 60 is translated towards the projecting element 40, the central rod 623 is inserted in the central hole 423 and remains positioned there. The projecting element 40 is thus attached to the locking element 60.

Advantageously, the central rod 623 has on its periphery notches which cooperate with the edge of the central hole 423, thereby helping to attach, by clipping, the locking element 60 and the projecting element 40 in the assembly position.

More generally, the body 62 (for example on the central rod 623, the lateral rods 622, or the arms 621) has reliefs adapted to cooperate with the locking element 40 in order to produce this attachment. These reliefs may be depressions such as notches, or projections such as gadroons.

The method for attaching the first part 10 to the second part 20 is described below, with reference to FIG. 1, FIG. 2 and FIG. 3.

FIG. 1 shows the first part 10 and the second part 20 before their assembly. The first part 10 has an outer surface 12 which is visible from outside the vehicle.

The projecting element 40 is located outside the hole of the guide member 50. The locking element 60 is in the upper position so that the head 61 of the locking element 60 projects from the outer surface 12 and is visible from the outside (step (a)).

FIG. 2 shows the first part 10 and the second part 20 once the projecting element 40 has been inserted in the hole of the guide member 50 through the opening 51. This insertion is carried out by translating the first part 10 along the main axis X of the projecting element 40 towards the second part 20, the flared shape of the guide member 50 having guided the projecting element 40 relative to the guide member 50. Alternatively, the second part 20 can be translated along the main axis X of the projecting element 40 towards the first part 10 (step (b)).

Since the diameter (or the thickness) of the projecting element 40 is substantially equal to the minimum inner diameter (or the minimum inner height) of the hole of the guide member 50, the first part 10 is held securely relative to the second part 20.

The total length L of the projecting element 40 is sufficiently large so that, in the locking position, at least part of the projecting element 40 is inserted in the straight portion 54 of the hole of the guide member 50. The clearance between the first part 10 and the second part 20 is thus minimised when these parts are in the final assembly position.

The locking element 60 is still in the upper position so that the body 62 of the locking element 60 does not interfere with the projecting element 40 as it translates in the hole of the guide member 50. When the locking element 60 is in the upper position, in fact, the distance between the arms 621 of the locking element 60 in the plane (perpendicular to the longitudinal direction of the locking element 60) containing the projecting element 40 is greater than the diameter of the projecting element at the groove 421. As indicated above, in fact, the distance between the arms 621 increases from the head 61 towards the distal end of the body 62 of the locking element 60.

FIG. 3 shows the first part 10 and the second part 20 after lowering by translation along the Y axis, separate from the main axis X, the locking element 60.

In the case illustrated on FIG. 3, the Y axis is perpendicular to the main axis X.

The locking element 60 is guided in its translation by two hollow protrusions 53 located on the edges of the opening 51 of the hole of the guide member 50, each side of this opening 51. The locking element 60 thus passes through the hollow central part of each hollow protrusion 53.

After it has been lowered, the arms 621 of the locking element 60 enter the groove 421 of the projecting element 40, thus preventing the projecting element 40 from being removed from the hole of the guide member 50. The first part 10 and the second part 20 are then attached together in the (final) assembly position (step (c)).

The table below provides examples of values for the different distances and angles characterising the geometry of the guide member 50 and of the projecting element 40 according to the invention, with reference to the embodiment illustrated on FIG. 1.

Advantageously, the total length L of the projecting element 40 is at least equal to the total length (including the length of the hollow protrusions 53) of the hole of the guide member, so that in the assembly position the projecting element 40 is pressed into this hole along the entire length A of the straight portion of this hole. The groove 421 of the projecting element 40 is then located at the proximal end of the projecting element 40.

| | | Ideal | Range of |
|---|---|---|---|
| | Refer- | value | possible |
| Description | ence | (mm) | values |
| Total length of the projecting element | L | 40 | 15 to 100 |
| Diameter of the projecting element and | D | 6 | 3 to 10 |
| of the straight portion of the hole of | | | |
| the guide member | | | |
| Length/diameter ratio | L/D | 6 | 3 to 10 |
| Diameter of the groove of the projecting | C | 4 | 2 to 9 |
| element | | | |
| Length of the straight portion of the hole | A | 12 | 4 to 30 |
| Distance between the hollow protrusions | B | 24 | 12 to 50 |
| Half-angle of the flare of the hole | β/2 | 35° | 25 to 60 |
| Length of the groove of the projecting | E | 6 | 2 to 10 |
| element | | | |

As indicated above, the hole of the guide member 50 has a straight portion 54, then a flared portion from this straight portion up to the opening 51 of the hole.

The position of the locking member 60 in the upper position relative to the projecting element 40 (as illustrated on FIG. 2) is always such that the body 62 does not interfere with the groove(s) (421, 422) or the hole (423) of the projecting element 40.

Conversely, in the lower position (as illustrated on FIG. 3, after translation along the Y axis towards the arrow), the body 62 of the locking member 60 cooperates with the groove(s) (421, 422) or the hole (423) of the projecting element 40 to prevent the projecting element 40 from being removed from the hole of the guide member 50.

Advantageously, as illustrated on FIG. 3, the head 61 of the locking element 60 closes an opening 13 in an outer surface 12 of the first part 10 in the assembly position, and the head 61 is then flush with the outer surface 12.

Thus, to close the opening 13 completely in the assembly position, the edges of the head 61 match the edges of the opening 13. This offers the advantage of improving the external appearance of the first part 10.

To prevent the head 61 from being pressed below the outer surface 12, the locking element 60 comprises a stop 629 which abuts on the projecting element 40, on the guide member 50, or on the first part 10 in the assembly position.

This situation occurs for all geometries of the locking element 60 described with reference to FIG. 4, FIG. 5, FIG. 6 and FIG. 7.

For example, as shown on FIG. 5, this stop 629 is a protrusion of the head 61, which is located between the arms 621 and which abuts on the bottom of the groove 421 of the projecting element 40 in the assembly position.

Alternatively, the stop 629 of the locking element 60 abuts on the guide member 50 in the assembly position.

This stop may also be a shoulder on the locking element 60.

This stop may also be the lower side of the head 61, which abuts on a flat of the first part 10 located set back (below) the outer surface 12 of the first part 10.

This configuration offers the advantage of improving the external appearance of the vehicle from the point of view of the external observer.

1. An assembly comprising a first part and a second part that is part of a body of a motor vehicle, said first part being intended for assembly on said second part, wherein
said second part comprises a projecting element extending along a main axis X,
said first part comprises a holder provided with a guide member for guiding said first part relative to said projecting element,
said holder supports an element for locking said projecting element in a position for assembly of said first part on said second part,
said locking element is configured to lock said projecting element in an assembly position via a movement along an axis separate from said main axis X.

2. The assembly according to claim 1, wherein said locking element comprises a stop which abuts on said projecting element, on said guide member, or on said first part in the assembly position.

3. The assembly according to claim 1, wherein said first part has an internal space housing said holder and said guide member, so that said holder and said guide member are invisible from outside said vehicle in the assembly position.

4. The assembly according to claim 3, wherein said locking element comprises a head which closes an opening in an outer surface of said first part in the assembly position, and which is flush with said outer surface.

5. The assembly according to claim 1, wherein said first part is a bumper.

6. The assembly according to claim 1, wherein said locking element comprises a body which cooperates with said projecting element to lock said projecting element in the assembly position.

7. The assembly according to claim 6, wherein said body comprises a fork with two arms, and said projecting element has a groove which receives said two arms in the assembly position.

8. The assembly according to claim 6, wherein said body comprises two lateral rods and said projecting element has two lateral grooves which each receive one of said two lateral rods in the assembly position.

9. The assembly according to claim 6, wherein said body comprises a central rod and said projecting element has a hole which is crossed by said central rod in the assembly position.

10. A method for assembling a first part on a second part that is part of the body of a motor vehicle, wherein this method comprises the following steps:
providing a first part which comprises a holder provided with a guide member, said holder supporting a locking element, and a second part which comprises a projecting element extending along a main axis X,
bringing said first part and said second part together so that said guide member guides said first part relative to said projecting element,
moving said locking element along an axis separate from said main axis X so as to lock said projecting element in the attachment position relative to said guide member, this attachment position being the assembly position.

11. The assembly according to claim 2, wherein said first part has an internal space housing said holder and said guide member, so that said holder and said guide member are invisible from outside said vehicle in the assembly position.

12. The assembly according to claim 4, wherein said first part is a bumper.
